(19) United States
(12) Patent Application Publication
(10) Pub. No.: US 2022/0316976 A1
(43) Pub. Date: Oct. 6, 2022

(54) REAL-TIME GAS LEAKAGE MONITORING SYSTEM

(71) Applicant: ABOCOM SYSTEMS, INC., Miaoli County (TW)

(72) Inventors: CHIH-YUAN LIN, MIAOLI COUNTY (TW); YEN-CHIH CHEN, MIAOLI COUNTY (TW); TE-LIEH PAN, MIAOLI COUNTY (TW); CHENG-HSIAO CHI, MIAOLI COUNTY (TW)

(21) Appl. No.: 17/572,647

(22) Filed: Jan. 11, 2022

(30) Foreign Application Priority Data
Mar. 31, 2021 (TW) 110112018

(51) Int. Cl. G01M 3/04; G08B 21/18; G08B 7/06

(52) U.S. Cl. CPC G01M 3/04; G08B 21/18; G08B 7/06

(57) ABSTRACT

A real-time gas leakage monitoring system applicable for a vacuum device includes an exhaust device connected to an exhaust end of the vacuum device. In addition to the use of the exhaust device for exhausting a gas from the vacuum device, a mass flow controller can also be connected to the exhaust end to receive the gas exhausted from the vacuum cavity and control a mass flow as a basis to determine a gas leakage setting value, and then a gas leakage detector is used to detect water and oxygen in the gas exhausted from the vacuum cavity. When water and oxygen are detected in the exhaust gas, it indicates a gas leakage status, and a warning signal can be outputted immediately to achieve the real-time gas leakage monitoring effect.

### CROSS-REFERENCE TO RELATED APPLICATIONS

This non-provisional application claims priority under 35 U.S.C. § 119(a) on Patent Application No(s). 110112018 filed in Taiwan, R.O.C. on Mar. 31, 2021, the entire contents of which are hereby incorporated by reference.

### BACKGROUND

### Technical Field

The present disclosure relates to a real-time gas leakage monitoring system, and more particularly to the real-time gas leakage monitoring system applied for detecting a vacuum device.

### Description of Related Art

An equipment requiring the use of vacuum, such as a metal organic chemical vapor deposition (MOCVD) equipment, an inductively coupled plasma (ICP) etcher, a reductive ion etching (RIE) system cannot monitored during its operation whether the equipment has leakage. Once a leakage occurs, the leakage cannot be known immediately, until the abnormality of the properties and appearance of the produced elements is confirmed, and then the detection and troubleshooting of the abnormal equipment will take place. For example, the detection and troubleshooting include the detection of an abnormal contact of the pipeline, a gap of the structure body formed by the external air inflow, or a diffusion entering into a low-pressure vacuum pipeline. The current manual abnormal equipment detection method is very troublesome and uneasy to find the problem of gas leakage, since the original equipment usually does not provide a leakage detection function, the existing semiconductor vacuum equipment pipeline is complicated, and the level of difficulty of the detection is relatively high. Therefore, how to improve the inability to monitor the gas leakage in real time is a problem that demands immediate attentions and feasible solutions.

### SUMMARY

In view of the problems of the prior art, it is a primary objective of the present disclosure to use a water oxygen detection method to monitor whether a vacuum device has a leakage of exhaust gas, and a secondary objective to provide a real-time gas leakage monitoring system capable of controlling the flow of exhaust gas of the vacuum cavity and using it as a basis to determine a gas leakage setting value, and the gas delivery pipeline is covered by a cooling water pipe for temperature control, which can improve the accuracy of the detection.

To achieve the foregoing and other objectives, the present disclosure discloses a real-time gas leakage monitoring system including a vacuum device, an exhaust device, a first gas delivery pipeline, a mass flow controller, a second gas delivery pipeline and a gas leakage detector. The vacuum device has a vacuum cavity and an exhaust end communicating with the vacuum cavity. The exhaust device is connected to the exhaust end, and the exhaust device discharges the exhaust gas out of the vacuum cavity. The first gas delivery pipeline has an end connected to the exhaust end for delivering the exhaust gas from the vacuum cavity. The mass flow controller is connected to the other end of the first gas delivery pipeline for receiving the exhaust gas of the vacuum cavity, and the mass flow controller controls the mass flow and uses it as a basis to determine a gas leakage setting value. The second gas delivery pipeline has an end connected to the mass flow controller for delivering the gas discharged from the vacuum cavity. The gas leakage detector is connected to the other end of the second gas delivery pipeline and provided for detecting water and oxygen in the exhaust gas of the vacuum cavity and outputting a detection signal. Wherein, the mass flow controller is provided for controlling the detection operation of the gas leakage detector, determining the detection signal, and outputting a warning signal when the detection signal is determined to be in a gas leakage status.

According to the aforementioned technical characteristic, the real-time gas leakage monitoring system further includes a cooling water circulation device disposed on a side of the vacuum device. The cooling water circulation device includes a first cooling water pipe and a second cooling water pipe, and the first cooling water pipe is provided for covering the outer side of the first gas delivery pipeline, and the second cooling water pipe is provided for covering the outer side of the second gas delivery pipeline, and the cooling water circulation device controls the cooling water circulation temperature of the water delivered by the first cooling water pipe and the second cooling water pipe.

In the aforementioned technical characteristic, the cooling water circulation temperature falls within a range of 0 to 5 degrees Centigrade.

In the aforementioned technical characteristic, the warning signal is gas leakage information, a buzzer, or both.

According to the aforementioned technical characteristic, the real-time gas leakage monitoring system further includes a display device connected to the vacuum device for displaying the warning signal.

According to the aforementioned technical characteristic, the real-time gas leakage monitoring system further includes a buzzer connected to the vacuum device, for outputting the warning signal.

In the aforementioned technical characteristic, the exhaust device includes a pneumatic valve, an exhaust gas delivery unit and a pump. The pneumatic valve is connected to the exhaust end for controlling the ON/OFF of the gas valve, and the exhaust gas delivery unit is connected between the pneumatic valve and the pump, and the pump is provided for discharging the gas from the vacuum cavity through the exhaust gas delivery unit.

According to the aforementioned technical characteristic, the real-time gas leakage monitoring system further includes an exhaust gas recycling unit connected to the exhaust device for recycling the exhaust gas of the vacuum cavity.

In the aforementioned technical characteristic, the gas leakage detector is a water and oxygen detector.

### BRIEF DESCRIPTION OF THE DRAWINGS

FIG. 1 is a system block diagram of the present disclosure;

FIG. 2 is a system block diagram showing the detailed structure of the present disclosure; and

FIG. 3 is a gas leak detection chart of the present disclosure.

### DESCRIPTION OF THE EMBODIMENTS

This disclosure will now be described in more detail with reference to the accompanying drawings that show various embodiments of the invention.

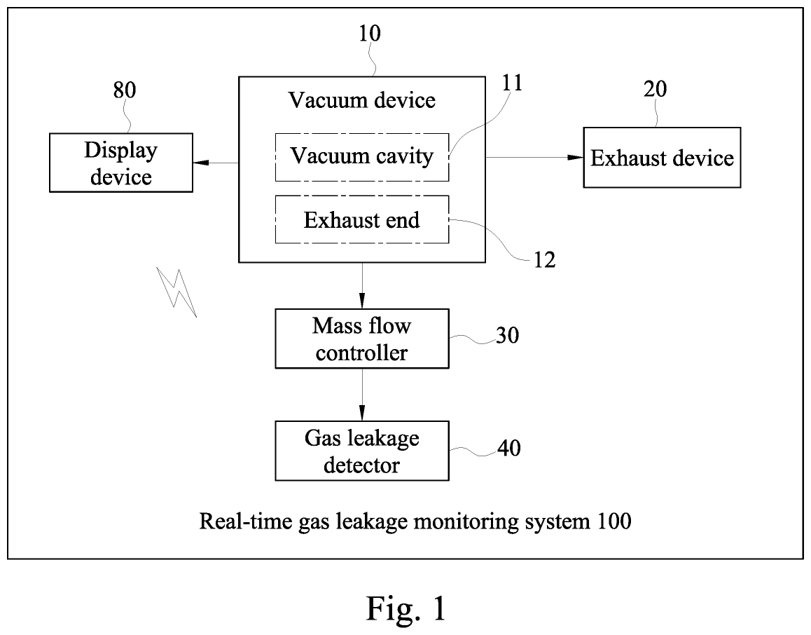

With reference to FIG. 1 for the system block diagram of a real-time gas leakage monitoring system of the present disclosure, the real-time gas leakage monitoring system 100 includes a vacuum device 10, an exhaust device 20, a mass flow controller 30, a gas leakage detector 40, a first gas delivery pipeline 50 and a second gas delivery pipeline 60. The vacuum device 10 has a vacuum cavity 11 communicating with an exhaust end 12 of the vacuum cavity 11, and the exhaust end 12 is provided for discharging a gas from the vacuum cavity 11. The exhaust device 20 is connected to the exhaust end 12, and the mass flow controller 30 is connected to the exhaust end 12 through the first gas delivery pipeline 50. In other words, the exhaust device 20 is connected to an end of the exhaust end 12, and the first gas delivery pipeline 50 is connected between a middle section of the exhaust end 12 and the mass flow controller for delivering the exhaust gas in the vacuum cavity 11, such that the mass flow controller 30 can draw out the exhaust gas of the vacuum cavity 11. The exhaust device 20 is provided for discharging the exhaust gas out of the vacuum cavity 11 directly. In addition, the real-time gas leakage monitoring system 100 further includes an exhaust gas recycling unit (not shown in the figure) connected to the exhaust device 20 and provided for recycling the gas discharged from the vacuum cavity 11.

The mass flow controller 30 is provided for receiving the exhaust gas of the vacuum cavity 11, controlling a mass flow, and using the mass flow as a basis to determine a gas leakage setting value. The gas leakage detector 40 is connected to the mass flow controller 30 through the second gas delivery pipeline 60, and the second gas delivery pipeline 60 is provided for delivering the exhaust gas of the vacuum cavity 11, so that the gas leakage detector 40 can detect the water and oxygen in the exhaust gas of the vacuum cavity 11. Wherein, the gas leakage detector 40 is a water and oxygen detector. In the environment of the vacuum device, water and oxygen will not exist theoretically, so that the present disclosure can use the water and oxygen detector for the gas leakage detection and outputs a corresponding detection signal after the detection. The mass flow controller 30 is provided for controlling the detection operation of the gas leakage detector 40, determining the detection signal, and outputting a warning signal when the detection signal is determined to be in a gas leakage status, wherein the warning signal can be gas leakage information, a buzzer or both. The warning signal can be transmitted to the outside via a cable or wireless transmission. Specifically, the real-time gas leakage monitoring system 100 further includes a display device 80 connected to the vacuum device 10 for displaying a warning signal such as gas leakage information, or the real-time gas leakage monitoring system 100 further includes a buzzer (not shown in the figure) connected to the vacuum device 10 for outputting the warning signal and sending a beep sound to remind the operator. Wherein, the buzzer can be integrated into the display device 80 according to the actual application requirements, so as to simultaneously display the gas leakage information and send the beep sound to remind the operator immediately and achieve the real-time gas leakage monitoring and warning effects.

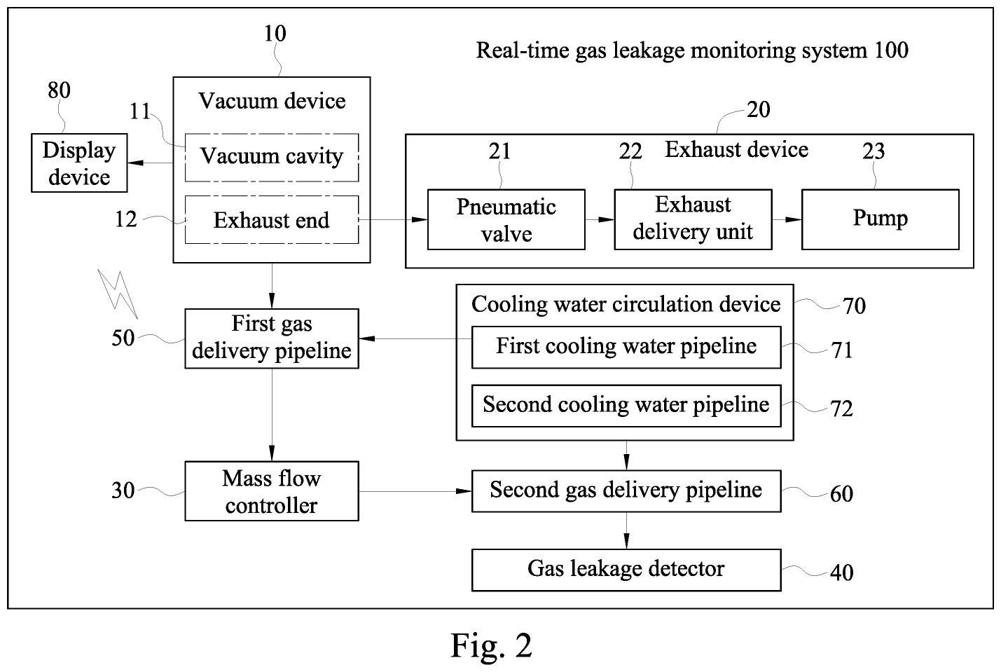

With reference to FIG. 2 for the schematic block diagram of the detailed structure of the present disclosure, the cooling water circulation device 70 is disposed on a side of the vacuum device 10, and the cooling water circulation device 70 includes a first cooling water pipe 71 and a second cooling water pipe 72. The first cooling water pipe 71 is provided for covering the outer side of the first gas delivery pipeline 50, and the second cooling water pipe 72 is provided for covering the outer side of the second gas delivery pipeline 60, and the cooling water circulation device 70 is provided for controlling the cooling water circulation temperature of the water delivered by the first cooling water pipe 71 and the second cooling water pipe 72, wherein the cooling water circulation temperature falls within a range of 0 to 5 degrees Centigrade.

In the aforementioned structural design, after the exhaust gas of the vacuum cavity 11 is discharged from the exhaust end 12, the mass flow controller 30 receives the exhaust gas of the vacuum cavity 11 through the first gas delivery pipeline 50 and controls the mass flow and uses the mass flow as the basis to determine a gas leakage setting value. Since the conditions of each application vary, the allowable gas leakage value is different, and the gas leakage setting value can be set according to the change requirements, and the present disclosure has no particular limitation on such value. The mass flow controller (MFC) 30 concurrently has the functions of a mass flow meter and an automatic control gas flow. In other words, the operator can set the flow according to the application requirements and the MFC will automatically keep the flow constantly at the setting value. Even if there is a fluctuation of the pressure of the vacuum device or a change of the ambient temperature, the flow will not deviate from the setting value. The gas leakage detector 40 is provided for receiving the exhaust gas of the vacuum cavity 11 through the second gas delivery pipeline 60 for detecting the water and oxygen in the exhaust gas of the vacuum cavity 11.

Since the application conditions of the vacuum device vary, therefore the system of this disclosure is necessary to operate together with the cooling water circulation device 70, and a covered cooling water flow path is used to cover the first cooling water pipe 71 and the second cooling water pipe 72 onto the outer side of the first gas delivery pipeline 50 and the second gas delivery pipeline 60 respectively, and the cooling water circulation device 70 is provided for controlling the cooling water circulation temperature of the water delivered by the first cooling water pipe 71 and the second cooling water pipe 72 to quickly cool down the exhaust gas discharged from the vacuum device 10 and lower the working temperature of the gas leakage detector 40, so as to ensure the accuracy of the detection. The cooling water circulation device 70 can set and control the water temperature and the water speed.

Wherein, the gas leakage detector 40 detects the water and oxygen in the exhaust gas of the vacuum cavity 11, uses a gas leakage detection method, and outputs a corresponding detection signal after the detection. If the mass flow controller 30 receives the detection signal and the detection signal is determined to be in a gas leakage status, the mass flow controller 30 will output a warning signal through a display device 80, a buzzer or both to remind the operator to achieve the real-time gas leakage monitoring and warning effects.

Wherein, the exhaust device 20 includes a pneumatic valve 21, an exhaust gas delivery unit 22 and a pump 23. The pneumatic valve 21 is connected to the exhaust end for controlling the ON/OFF of the gas valve. The exhaust gas delivery unit 22 is connected between the pneumatic valve 21 and the pump 23. The pump 23 pumps the gas from the vacuum cavity 11 through the exhaust gas delivery unit 22. Wherein, the pump 23 can be connected to the exhaust gas recycling unit for recycling the exhaust gas of the vacuum cavity 11. Since the vacuum exhaustion is a prior art, its description will not be repeated. In addition, the gas leakage detector 40 can be externally connected to a pipeline which will deliver the detected gas to the exhaust gas recycling unit.

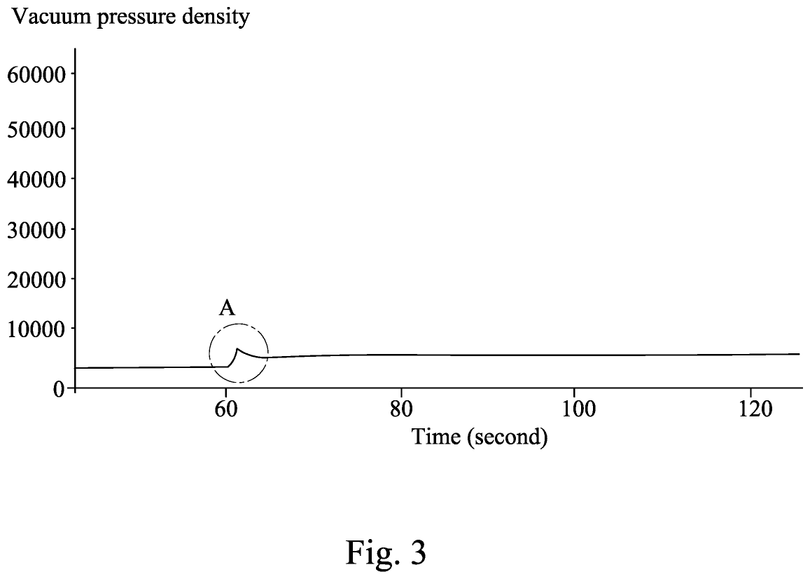

With reference to FIG. 3 for a gas leak detection chart of the present disclosure, once the vacuum device 10 is turned on, the vacuum exhaust process takes place, and the mass flow controller 30 draws the exhaust gas of the vacuum cavity 11 through the first gas delivery pipeline 50 and delivers the exhaust gas of the vacuum cavity 11 through the second gas delivery pipeline 60 to the gas leakage detector 40 for detection. In the gas leakage status A as shown in the figure, the mass flow controller 30 outputs a warning signal to remind the operator through a display device 80, a buzzer or both, so as to achieve the real-time gas leakage monitoring and warning effects.

In summation of the description above, the present disclosure breaks through the prior art and provides a real-time gas leakage monitoring system with a novel design using the water oxygen detection method to monitor whether a vacuum device has a gas leakage of the exhaust gas in real time, and this system is applicable to any vacuum device such as a metal organic chemical vapor deposition (MOCVD) equipment, an inductively coupled plasma (ICP) etcher, a reductive ion etching (RIE) system, a vacuum evaporation equipment (MBE), etc. The present disclosure comes with a simple improved structural design and achieves the required stability and accuracy of the operation and the expected improvement effect, which is not easily conceivable by a person having ordinary skill in the art. In addition, the present disclosure has not been disclosed prior to its application and it is inventive, practical, useful and in compliance with the patent application requirements, and is thus duly filed for patent application.

What is claimed is:

1. A real-time gas leakage monitoring system, comprising:
a vacuum device, having a vacuum cavity, and an exhaust end communicating with the vacuum cavity, for discharging a gas in the vacuum cavity out of the vacuum cavity;
an exhaust device, coupled to the exhaust end, for discharging the gas from the vacuum cavity;
a first gas delivery pipeline, with an end coupled to the exhaust end, for delivering the gas discharged from the vacuum cavity;
a mass flow controller, coupled to the other end of the first gas delivery pipeline, for receiving the gas discharged from the vacuum cavity, and controlling a mass flow as a basis to determine a gas leakage setting value;
a second gas delivery pipeline, with an end coupled to the mass flow controller, for delivering the gas discharged from the vacuum cavity; and
a gas leakage detector, coupled to the other end of the second gas delivery pipeline, for detecting water and oxygen in the gas discharged from the vacuum cavity and outputting a detection signal;
wherein the mass flow controller is provided for controlling a detection operation of the gas leakage detector and determining the detection signal, and outputting a warning signal when the detection signal is determined to be in a gas leakage status.

2. The real-time gas leakage monitoring system according to claim 1, further comprising a cooling water circulation device disposed on a side of the vacuum device, and the cooling water circulation device comprising a first cooling water pipe and a second cooling water pipe, and the first cooling water pipe being provided for covering outer side of the first gas delivery pipeline, and the second cooling water pipe being provided for covering outer side of the second gas delivery pipeline, and the cooling water circulation device being provided for controlling a cooling water circulation temperature of a cooling water delivered by the first cooling water pipe and the second cooling water pipe.

3. The real-time gas leakage monitoring system according to claim 2, wherein the cooling water circulation temperature falls within a range from 0 to 5 degrees Centigrade.

4. The real-time gas leakage monitoring system according to claim 1, wherein the warning signal is gas leakage information, a buzzer, or both.

5. The real-time gas leakage monitoring system according to claim 1, further comprising a display device, coupled to the vacuum device, for displaying the warning signal.

6. The real-time gas leakage monitoring system according to claim 1, further comprising a buzzer coupled to the vacuum device for outputting the warning signal.

7. The real-time gas leakage monitoring system according to claim 1, wherein the exhaust device comprises a pneumatic valve, an exhaust gas delivery unit and a pump, and the pneumatic valve is coupled to the exhaust end for controlling the ON/OFF of the gas valve, and the exhaust gas delivery unit is coupled between the pneumatic valve and the pump, and the pump discharges the gas from the vacuum cavity through the exhaust gas delivery unit.

8. The real-time gas leakage monitoring system according to claim 1, further comprising an exhaust gas recycling unit coupled to the exhaust device for recycling the gas discharged from the vacuum cavity.

9. The real-time gas leakage monitoring system according to claim 1, wherein the gas leakage detector is a water and oxygen detector.
